(19) United States
(12) Patent Application Publication
(10) Pub. No.: US 2005/0254239 A1
(43) Pub. Date: Nov. 17, 2005

(54) Decoration having double light sources

(76) Inventor: Fong-Shi Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/844,414

(22) Filed: May 13, 2004

(51) Int. Cl. F21S 4/00; F21S 2/00

(52) U.S. Cl. 362/227

(57) ABSTRACT

The invention relates to a decoration having double light sources, which includes a holder to connect with a lamp thereon. The holder is made of transparent material and is provided with inner lamp. Hence, the decoration has two light sources including the external lamp and inner lamp that reaches the purpose of this design.

### BACKGROUND OF THE INVENTION

A conventional lighting decoration, which includes a holder to connect with a lamp, has only one external lamp to emit light and to form the lighting effect. Although the holder can be designed to be various patterns, it has the single function of holding the lamp without other specialty.

### SUMMARY OF THE INVENTION

The present invention is to provide a decoration, which has two light sources for providing its novel and special decorative effect. Now, accompanying with the following drawings, the character of the present invention will be described here and after.

### BRIEF DESCRIPTION OF THE DRAWINGS

FIG. 1 is a perspective view showing a decoration having double light sources according to the present invention.

FIG. 2 is a cross-sectional plan view of FIG. 1.

FIG. 3 is a cross-sectional view showing another embodiment of the present invention.

FIG. 4 is a plan view showing an application according to the present invention.

### DETAILED DESCRIPTION OF THE PREFERRED EMBODIMENT

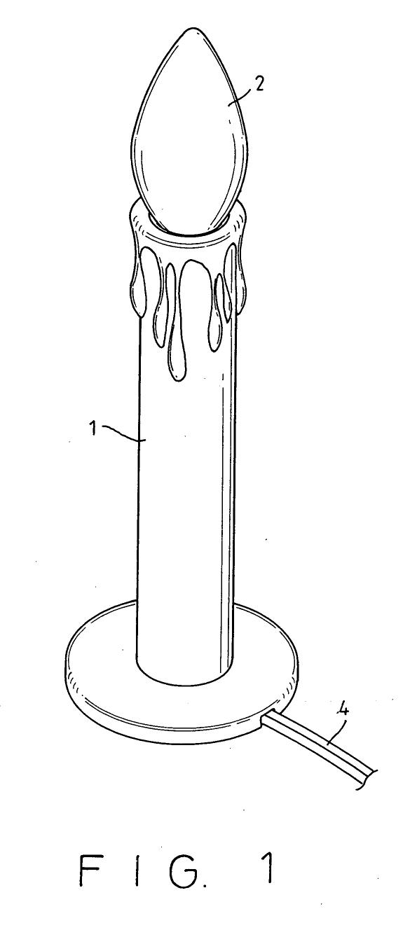

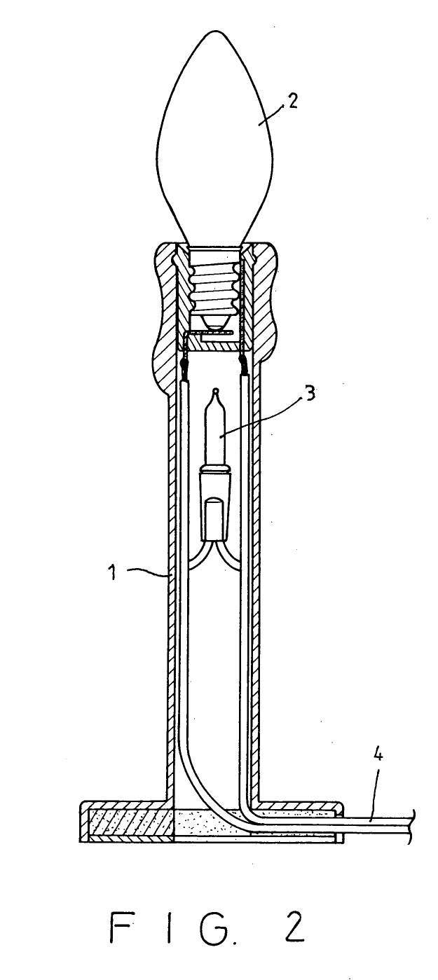

Please referring to FIGS. 1 and 2, the present invention relates to a decoration having double light sources, which includes a holder (1), being able to be any various shape, and a candle in this specification for example. An external lamp (2) is connected on the holder (1) and an inner lamp (3) is provided in the holder (1), both of which are electrically connected by electrical wire (4) extending outward for connection with power supply. The holder (1) is made of material being light transparent. Hence, when turn on the power, the external lamp (2) becomes a direct light source and the inner lamp (3) can emit its light through the holder (1) to be another different light source that obtains the double light sources of special decorative effect.

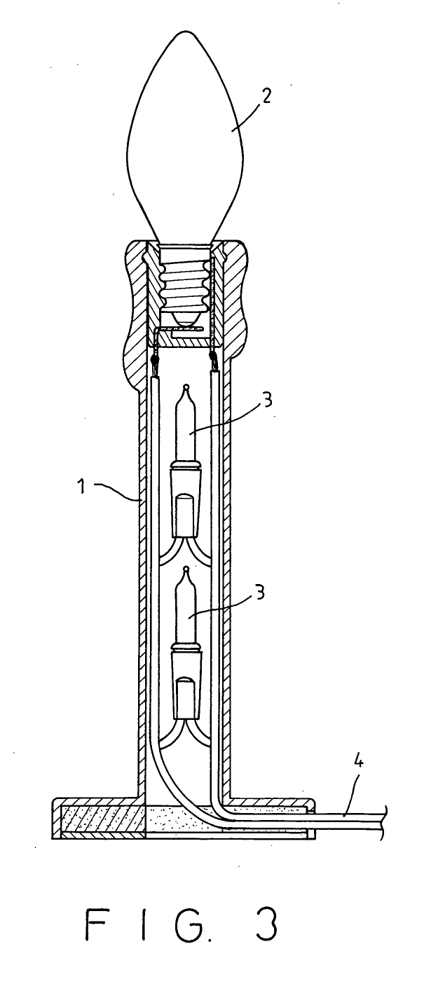

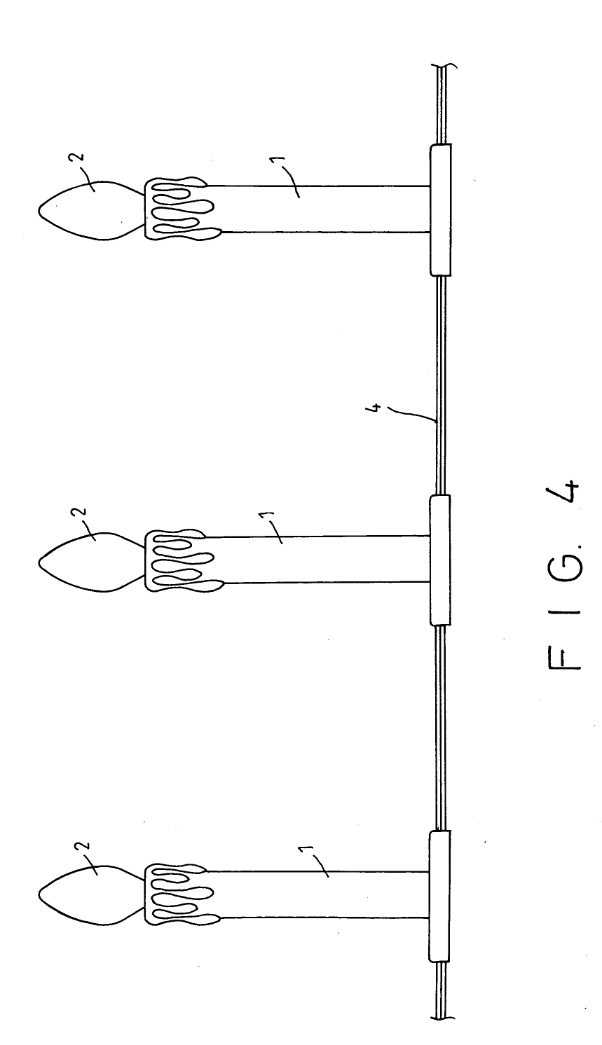

As shown in FIG. 3, the holder (1) is provided with more than one inner lamp (3) to increase the lighting effect. In application of FIG. 4, it shows the decoration can be assembled with several holders having double light sources to form another utilization. Those are also included in the spirit of the present invention.

1. A decoration having double light sources including a holder, which connects with an external lamp thereon and is made of material being light transparent, and an inner lamp being provided in the holder to obtain double light sources.

2. A decoration having double light sources as claimed in claim 1, wherein the holder can be various designed patterns.

3. A decoration having double light sources as claimed in claim 1, wherein the inner lamp provided in the holder can be more than one.
